(19) United States
(12) Patent Application Publication
(10) Pub. No.: US 2011/0099501 A1
(43) Pub. Date: Apr. 28, 2011

(54) PREVIEWING AND EDITING PRODUCTS IN A PRODUCT SELECTION AND MANAGEMENT WORKFLOW

(76) Inventors: Russell Mull, Corvallis, OR (US); Marc Frederick Ayotte, Corvallis, OR (US); Phil Manijak, Corvallis, OR (US); Michael R. Wilson, Corvallis, OR (US)

(21) Appl. No.: 12/607,805

(22) Filed: Oct. 28, 2009

(51) Int. Cl. G06F 3/048

(52) U.S. Cl. 715/771; 715/838

(57) ABSTRACT

A method for previewing a plurality of products populated with a plurality of digital images includes identifying a layout of a selected product page of a selected one of the plurality of products and identifying one or more controls that correspond to the identified layout. In a user interface, a display is caused of the identified controls and a preview image of the selected product page.

### BACKGROUND

Consumers order single and multi-image products via kiosks and web services. Single image products include image prints of various sizes. Multi-image products include collage posters, photo books, calendars, and the like. Certain multi-image products such as photo books and calendars are also multi-page products. Within a given multi image product, one page may include a single image while another includes multiple images. Challenges arise in presenting user interface controls for previewing and editing such disparate product types within a single workflow.

### DRAWINGS

FIGS. 1 and 2 depict exemplary environments in which embodiments may be implemented.

FIGS. 3-18 depict exemplary screen views of a user interface according to embodiments.

FIG. 19 depicts an exemplary product preview system according to an embodiment.

FIGS. 20-21 are block diagrams of environments in which the system of FIG. 13 may be implemented.

FIG. 22 is a flow diagram depicting steps take to implement an embodiment.

### DETAILED DESCRIPTION

Various embodiments described below operate to provide a common workflow for selecting and managing single and multi image products as well as single and multi-page products. Within that workflow, the user is presented with a user interface for previewing and editing various selected products. To allow for disparate product types, the specific user interface controls displayed are automatically selected based on the layout of the particular product page being previewed. The term layout as used herein refers to the number of images included on a page and the number of pages in a product. For multi-page products the term layout also refers to the page's orientation with respect to other pages of that multi-page product and the page's position within a sequence of pages.

Certain controls are displayed for pages that include a single image, while other controls are presented for pages that include multiple images. The displayed controls can include page editing, image editing, and page browsing controls. Page editing controls are controls that, when manipulated by a user, are intended to alter the appearance of a selected product page. Such page editing controls may affect the appearance of multiple images. Image editing controls are controls that, when manipulated by a user, affect a single image. Certain page editing and image editing controls correspond to product pages that include a single image while other page editing and image editing controls correspond to product pages that include multiple images. Page browsing controls are controls that, when manipulated by a user, cause the display of a selected page of a multi-page product. For multi-page products, different page browsing controls correspond to each page of that product. Further, the page browsing controls that correspond to a multi-page product with a vertical binding can differ from the page browsing controls that correspond to a product with a horizontal binding.

The following description is broken into sections. The first, labeled “Environment,” describes exemplary environments in which embodiments may be implemented. The second section, labeled “Workflow,” describes a series of exemplary screen views depicting a common workflow for selecting, editing, and previewing single and multi-image products. The third section, labeled as “Components”, describes physical and logical components of various embodiments. The last section, labeled “Operation,” describes steps taken to implement various embodiments.

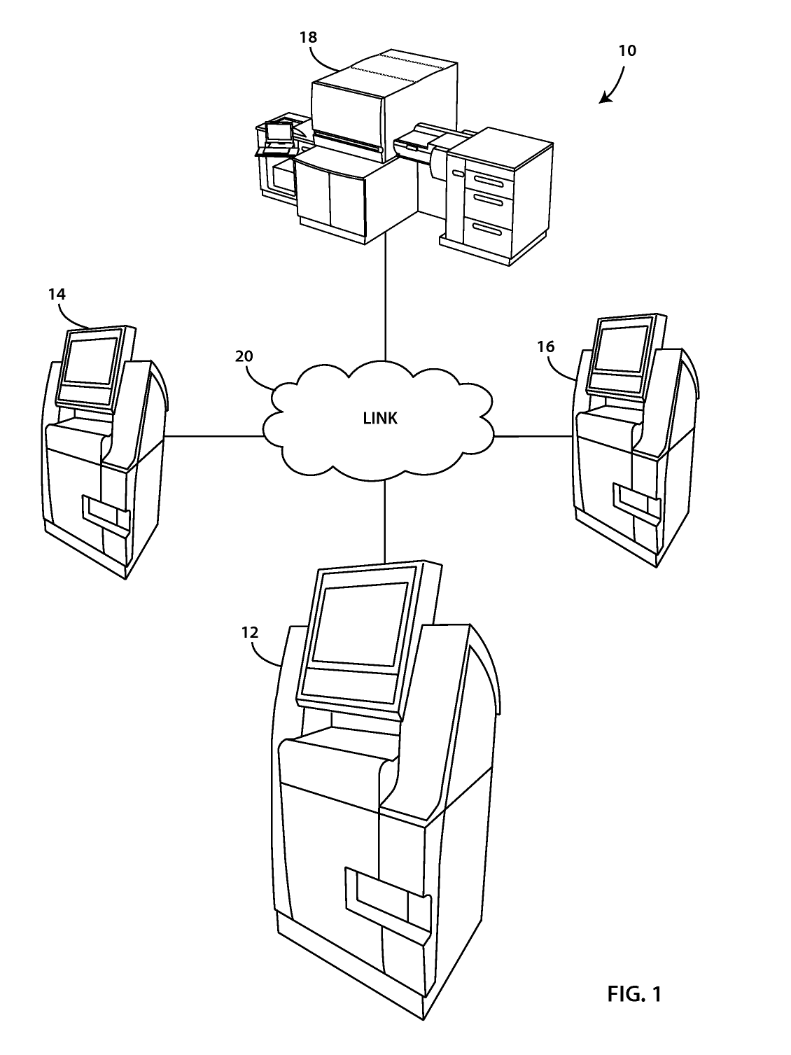

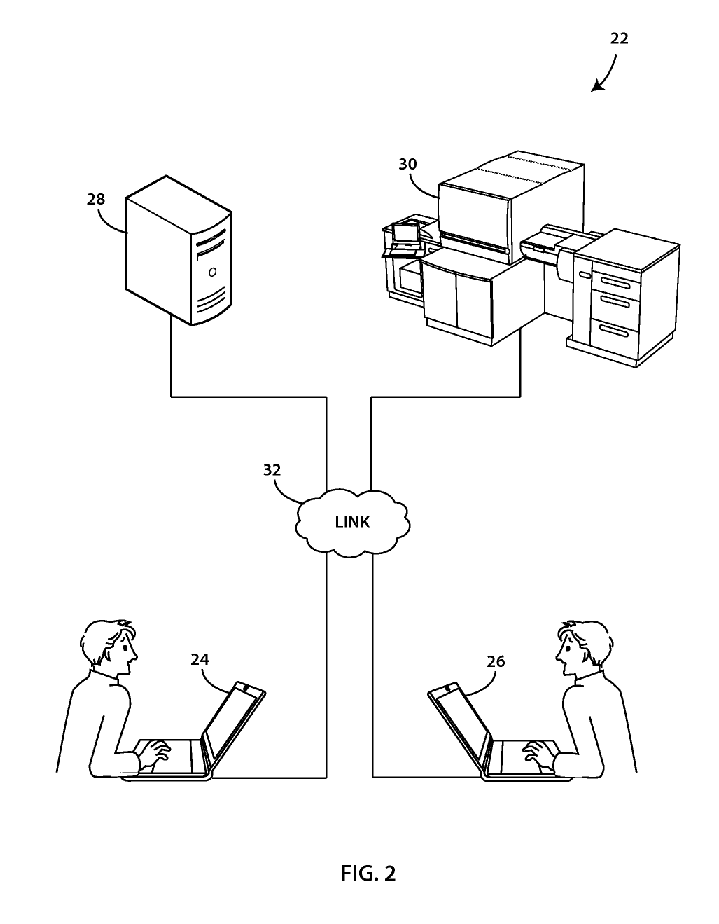

ENVIRONMENT: FIGS. 1-2 depict exemplary environments in which embodiments may be implemented. Starting with FIG. 1, environment 10 includes kiosks 12, 14, and 16 and production service 18 interconnected via link 20. Kiosks 12-16 each represent a computing device through which a user can select, edit, and order single and multi-image products. Each kiosk 12-16 presents a user interface via a display device. Often this display device incorporates a touch screen allowing the user to manipulate various controls with the touch or slide of a finger. Accessing digital images via a memory card or the internet, programming on each kiosk 12-16 allows a user to select from among the digital images, edit selected digital images, and order single and multi-image products populated with selected digital images.

Production service 18 represents generally any device or collection of devices capable of producing single and multi-image products ordered via kiosks 12-16. Link 20 represents generally one or more of a cable, wireless, fiber optic, or remote connection via a telecommunication link, an infrared link, a radio frequency link, or any other connector or system that provides electronic communication. Link 20 may represent an intranet, the Internet, or a combination of both. The paths followed by link 20 between kiosks 12-16 and production service 18 as depicted in FIG. 1 represent the logical communication paths between these devices, not necessarily the physical paths between the devices.

FIG. 2 depicts another environment 22 in which embodiments may be implemented. Environment 22 is shown to include client devices 24 and 26, server device 28, and production service 30 interconnected via link 32. Client devices 24 and 26 represent generally any computing devices capable of visually presenting a graphical user interface to a user and receiving user input via a touch screen, mouse, and/or a keyboard. Server device 28 represents generally any computing device capable of serving content to client devices 24, 26 that enable users to order single and multi-image products. Accessing digital images from client devices 24 or 26 or stored locally, server device 28 serves web pages or other content enabling users to select from among the digital images, edit selected digital images, and order single and multi-image products populated with selected digital images.

Production service 30 represents generally any device or collection of devices capable of producing single and multi-image products ordered via client devices 24, 26 and server device 28. Link 32 represents generally one or more of a cable, wireless, fiber optic, or remote connection via a telecommunication link, an infrared link, a radio frequency link, or any other connector or system that provides electronic communication. Link 32 may represent an intranet, the Internet, or a combination of both. The paths followed by link 32 between devices 24-30 as depicted in FIG. 2 represent the logical communication paths between these devices, not necessarily the physical paths between the devices.

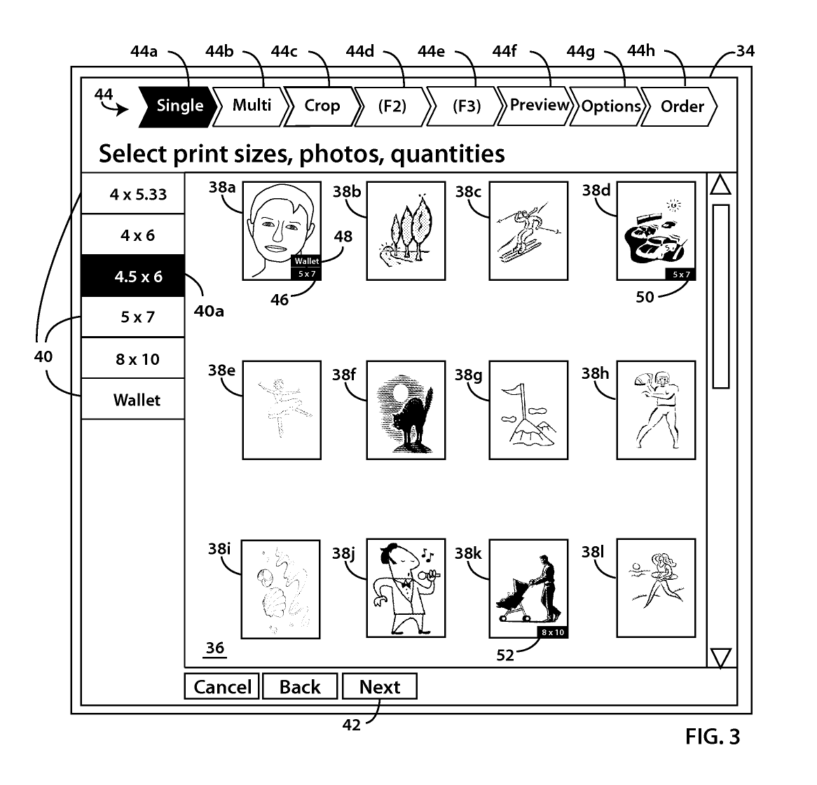

WORKFLOW: FIGS. 3-15 depict exemplary screen views of a user interface 34 through which a user can preview single and multi-image products selected via a common workflow. The term workflow as used herein refers to a defined series of tasks for producing a final outcome. From a user's perspective, initial tasks involve a user's selection from among various single and multi-image products as well as the user's selection of digital images for populating those products. A subsequent task can include previewing and editing selected products. A final task may involve placing an order. Ordering, for example, can include sending a job or jobs to a production service requesting the production of one or more user selected, populated, and edited products.

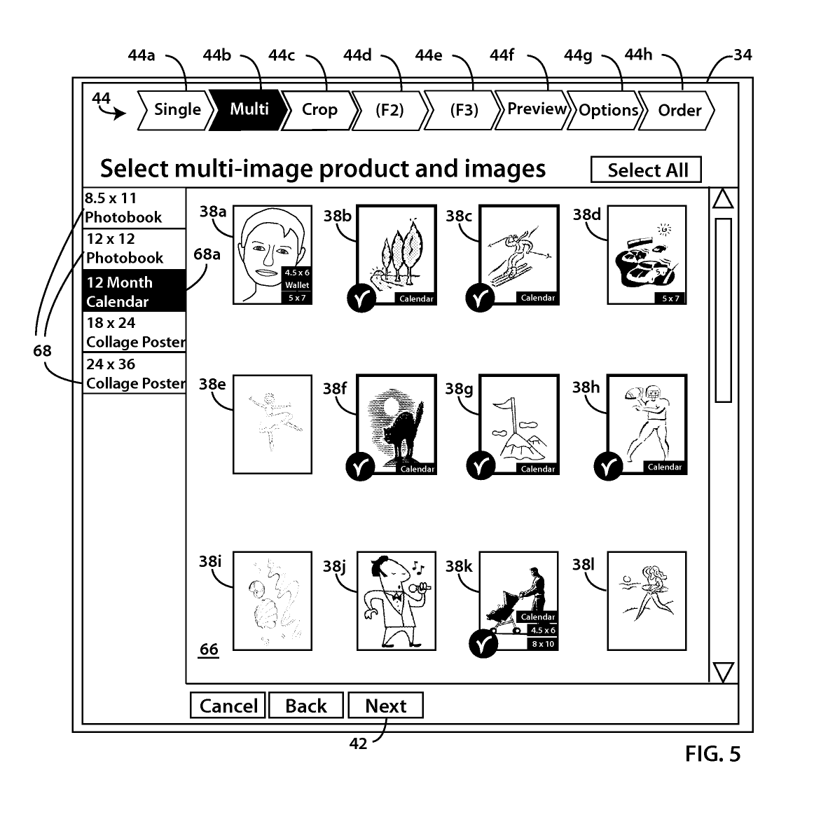

Starting with FIG. 3, user interface 34 is shown to include frame 36. The term frame as used refers to a defined area within user interface 34 for displaying text and graphics. As will be seen with respect to FIGS. 5-15, user interface 34 includes multiple frames. Some are displayed together at the same time while others are displayed sequentially as a user proceeds through the workflow. Displayed within frame 36 are thumbnails 38a-38l, referred to collectively as thumbnails 38. Each thumbnail 38 is a user selectable control providing a visual representation of a given digital image. In other words, a user selects a given digital image by selecting a corresponding thumbnail 38. Frame 36 is also shown to include product controls 40 for selecting from among a number of single image products.

User interface 34 includes workflow control 42 and workflow indicator 44. Workflow control 42 represents generally a user selectable control or controls enabling a user to sequence through various tasks of the workflow. Workflow indicator 44 represents a graphic or textual indication of an active task within the workflow. In the example of FIG. 3, task 44a is highlighted within task indicator 44. Task 44a involves the selection of print sizes, digital images, and quantities for single image products identified by product controls 40. Here a user has selected product control 40a corresponding to 4.5×6 prints. While no thumbnails 38 have been selected for 4.5×6 single image prints, thumbnail 38a has been modified with marking 46 and 48 to indicate that the user has previously selected the corresponding digital image to be used in producing a 5×7 single image print and wallet sized prints. Thumbnail 38d has been modified with marking 50 to indicate that the user has previously selected the corresponding digital image to be used in producing a 5×7 single image print. Finally, thumbnail 38k has been modified with marking 52 to indicate that the user has previously selected the corresponding digital image to be used in producing an 8×10 single image print.

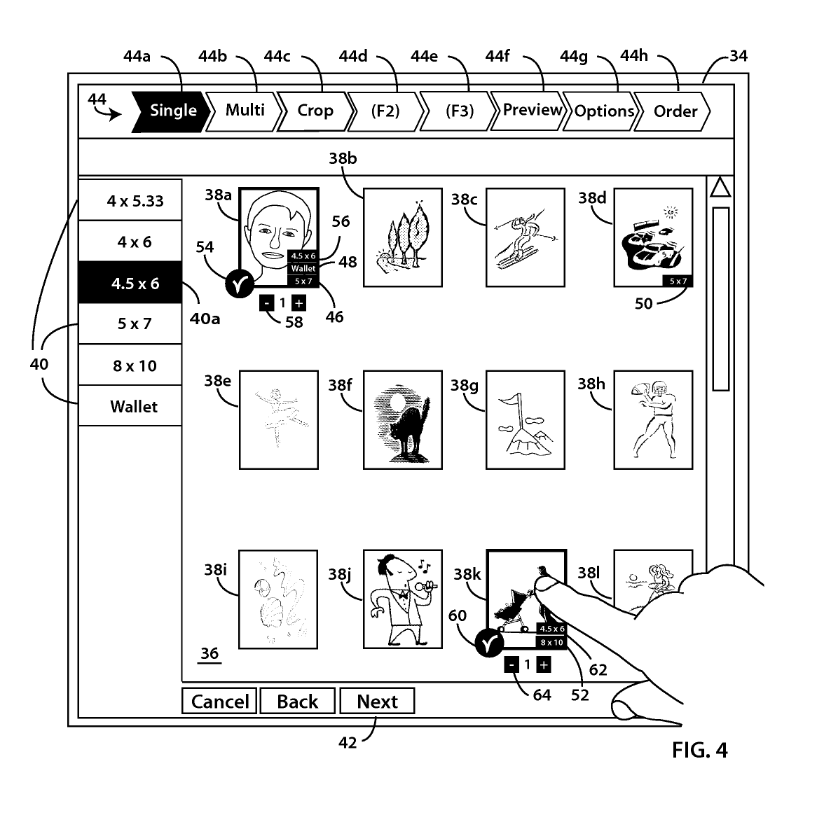

Moving to FIG. 4, the user has selected thumbnails 38a and 38k. As a result, thumbnail 38a has been modified with markings 54-58, and thumbnail 38d has been modified with markings 60-64. Markings 54 and 60 each provide an indication that a given thumbnail 38a and 38k has been selected with respect to currently selected product control 40a. Markings 56 and 62 indicate that the user has selected the corresponding digital images to be used in producing a 4.5×6 single image print. Markings 58 and 64 represent user selectable controls for selecting a number of 4.5×6 single image prints for each corresponding digital image. Here the user has indicated a desire for one 4.5×6 single image print for the digital images represented by thumbnails 38a and 38k.

With respect to FIGS. 3 and 4, the user's selection of the Wallet product control 40 followed by a selection of thumbnail 38a updated a list, often referred to as an electronic shopping cart, to include an order for a wallet print of the digital image represented by thumbnail 38a. The user's selection of the 8×10 product control 40 followed by a selection of thumbnail 38k updated the list to include an order for an 8×10 single image print of the digital image represented by thumbnail 38k. The user's selection of the 5×7 product control 40 followed by the selection of thumbnails 38a and 38d updated the list to include an order for a 5×7 single image print of the digital image represented by thumbnails 38a and 38d. The user's selection of the 4.5×6 product control 40a followed by the selection of thumbnails 38a and 38k updated the list to include an order for a one 4.5×6 single image print for each of the digital images represented by thumbnails 38a and 38k.

Assuming the user has finished selecting single image products, the user selects workflow control 42 stepping ahead to the next task in the workflow. Referring to FIG. 5, that next task is the selection of multi-image products and corresponding digital images for populating those products. The selection of workflow control 42 in FIG. 3 caused an update of workflow indicator 44 to indicate the current task 44b of selecting a multi-image product and digital images for populating the selected product. Replacing frame 36, user interface 34 now includes frame 66. Frame 66 includes thumbnails 38a-38l and product controls 68.

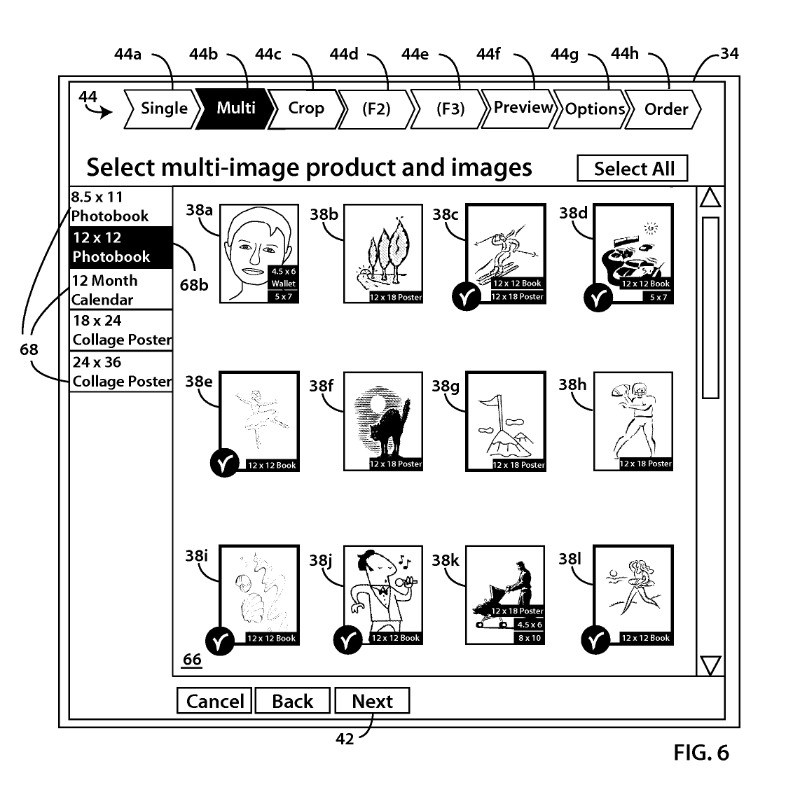

Product controls 68 allow a user to select from among a number of multi-image products. Here control 68a has been selected for a 12 month calendar. With control 68a selected, the user selects from among thumbnails 38a-38l to populate product a multi-image product. Here the user has selected thumbnails 38b, 38c, 38f, 38g, 38h, and 38k. The selection of product control 68a followed by the selection of thumbnails 38b, 38c, 38f, 38g, 38h, and 38k updated the list, discussed above, to include an order for a 12 month calendar populated with digital images corresponding to the selected thumbnails. Moving to FIG. 6, the user has selected product control 68b corresponding to a 12×12 photobook. To populate the photobook, the user has selected digital images represented by thumbnails 38c, 38d, 38e, 38i, 38j, and 38l. As a result, the list is updated to include an order for the photobook.

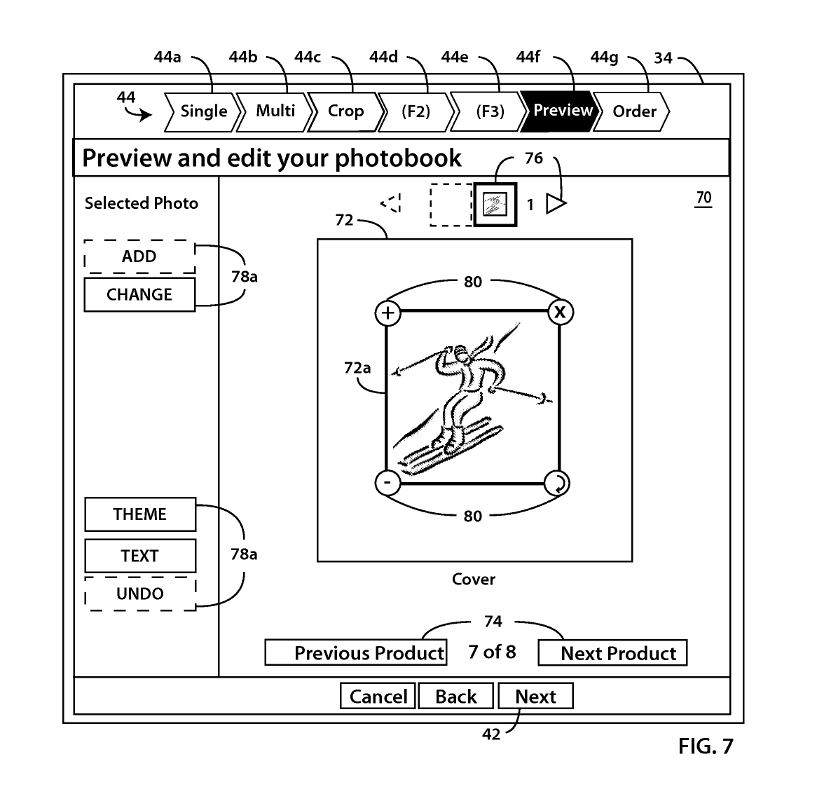

After the user has finished selecting multi-image products, the user manipulates workflow control 42 to step though various tasks. Referring to FIGS. 7-15, the user has moved ahead to task 44f which includes previewing and editing selected products. Replacing frame 66, user interface 34 now includes frame 70. Frame 70 includes page preview image 72, product browsing controls 74, page browsing controls 76, page edit controls 78a, and image edit controls 80. Page preview image 72 is a visual depiction of a page of one of a set of products that were selected during a previous task in workflow 44. The particular product being previewed is selected by manipulating controls 74. The particular page is selected by manipulating page controls 76. Here, the particular product is the photo book, and the particular page is a cover that includes a single image 72a.

The specific controls 76, 78a, and 80 displayed are automatically selected based on the layout of the particular page depicted by page preview image 72. The term layout as used herein refers to the number of images included on a page. For multi-page products the term layout also refers to the page's orientation with respect to other pages of that multi-page product and the page's position within the sequence of pages. In the Example of FIG. 7, preview image 72 is for a single image cover page of a photobook. The pages of the photobook have a vertical binding providing the pages with a side-by-side orientation. Page browsing controls 76 are selected to mimic the side-by-side orientation of the pages of the photobook. Page editing controls 78a and image editing controls 80 relevant to a single image page are selected and displayed.

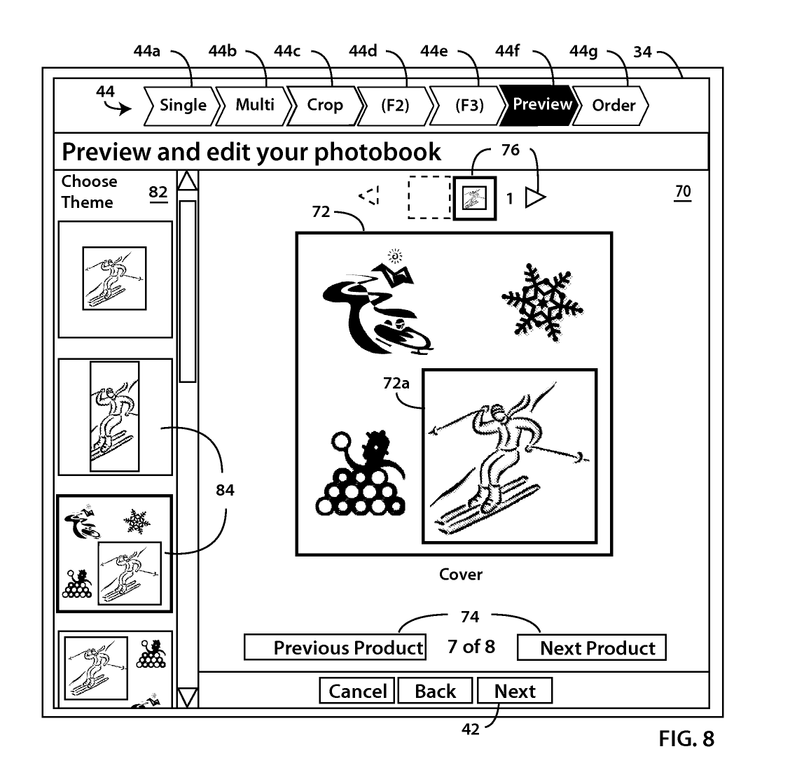

The selected page editing controls 78a, in the example of FIG. 7, include a control for changing the image included on the cover page, a control for updating the theme of the cover page, and a control for adding text. A control for adding an image is shown in broken lines as it is not applicable to the single image cover page of the photobook. A control for undoing an action is shown in broke lines as no action has been taken that can be undone. Image editing controls 80 include controls for resizing, rotating, and removing selected image 72a. Following a user's selection of the “theme” page control 78 in FIG. 7, frame 70 is updated to include theme overlay 82 as depicted in the Example of FIG. 8. Theme overlay 84 includes a series of theme selectors 84. Upon selection of a given theme selector, a corresponding updated preview image 72 is displayed.

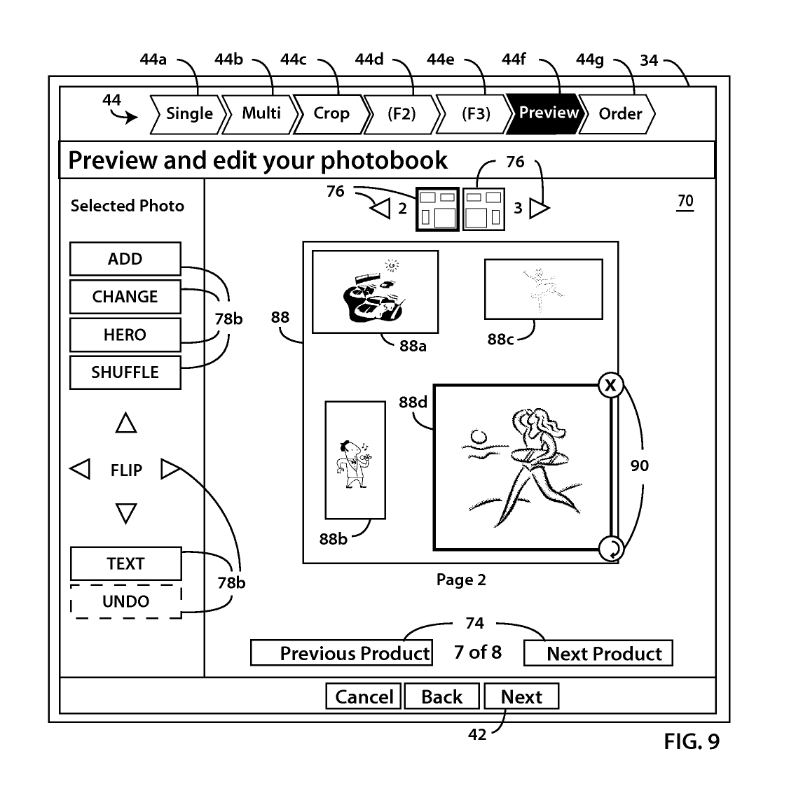

Moving to FIG. 9, a user has manipulated page browsing control 76 to move to the next page of the photobook. As a result, frame 70 is updated with page preview image 88 providing a visual depiction of the next page of the photobook. In this example, the next page is a multi-image page containing images 88a, 88b, 88c and 88d. The user has selected image 88d causing the display of image edit controls 90. Page edit controls 78b and image edit controls 90 selected to be displayed correspond to the new multi-image layout of preview image 88 and differ from their counterparts selected with respect to the layout of the cover page as depicted in FIG. 7. Furthermore, page browsing controls 76 have been updated to reflect the preview position within the photobook and the selection of the second page.

As noted, the page edit controls 80a selected to be displayed correspond to a multi-image page and include controls for adding an image to a page, changing a selected image, promoting a selected image to “hero” status, and shuffling the images included on the page. Other page editing controls 80a allow a user to add text, “flip” the layout of the included images, and undo previous page editing actions. Here, no page editing actions have occurred, so the “undo” page editing control is not active and is shown in broken lines.

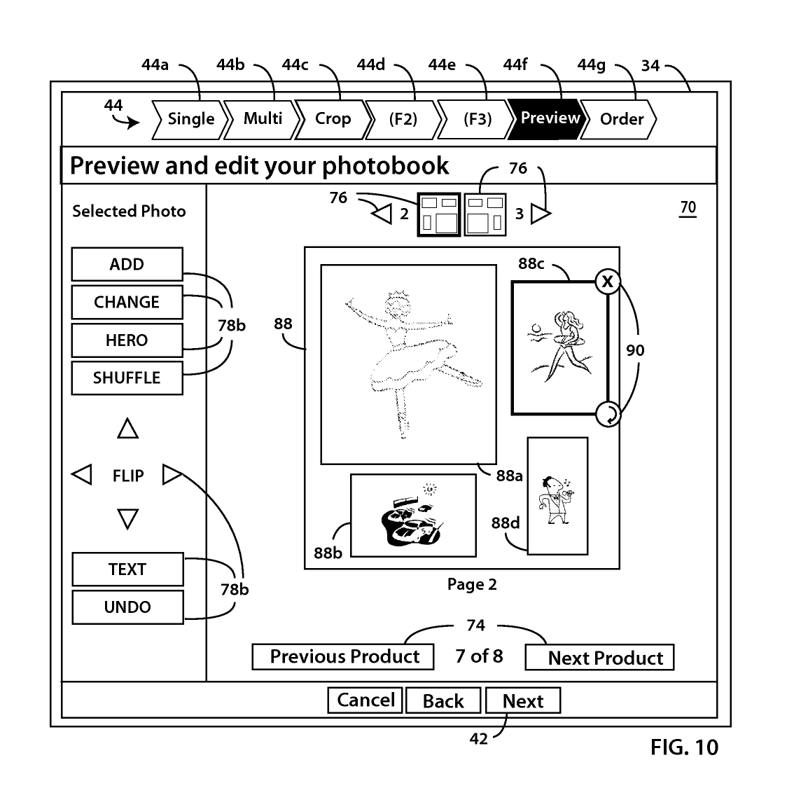

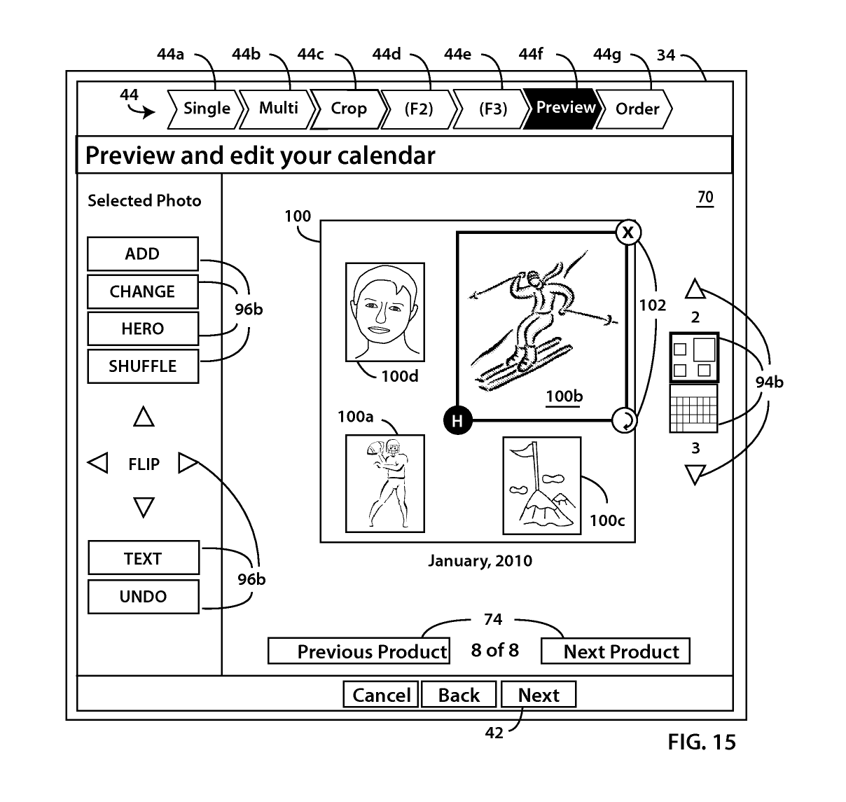

The “add’ page editing control 78b, when selected, allows the user to add an image to the select page. The “change” page editing control 78b allows a user to replace a selected image with another. Promoting a selected image to “hero” status enlarges the selected image with respect to the others included on the given page. An example is discussed below with respect to FIG. 15. Following the user's selection of the “shuffle” page editing control 78b, the positioning of images 88a-88d are shuffled causing a display of an updated preview image 88 as depicted in FIG. 10. Note that, in addition to repositioning the images, each image 88a-88d may also be resized. Following the user's selection of the “shuffle” page editing control 78b, the “undo” page editing control 78b is activated. Should the user select the “undo” page editing control 78b, the relative positioning of images 88a-88d are restored to their previous arrangement as depicted in FIG. 9.

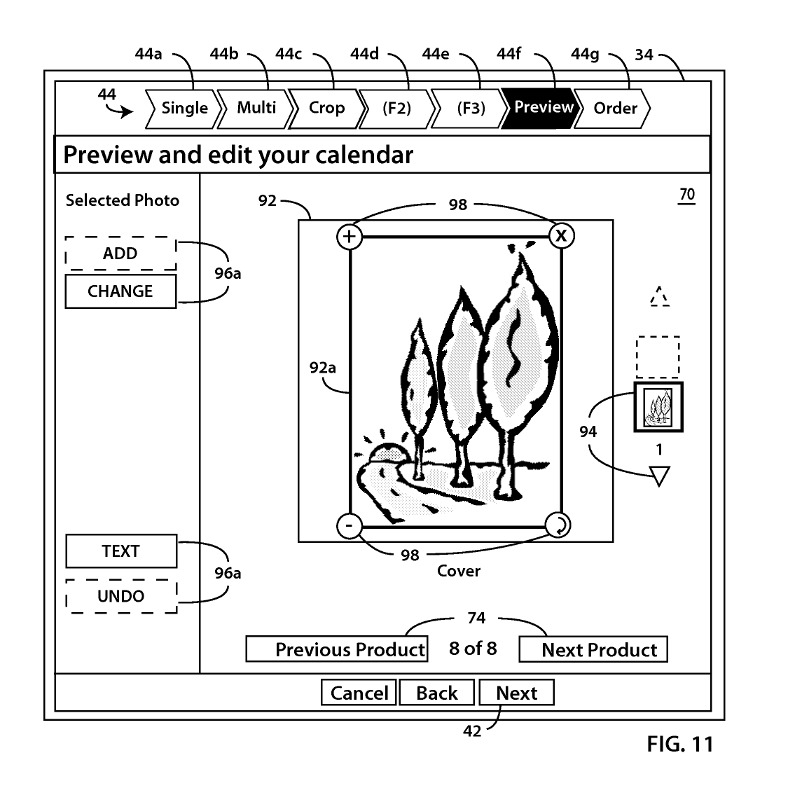

Moving to FIG. 11, the user has manipulated product selection controls 74 moving the focus to another selected product, in this example, the calendar. As a result, frame 70 has been updated with page preview image 92, page browsing controls 94, page editing controls 96a, and image editing controls 98. Preview image 92 provides a visual depiction of a selected calendar page. Here, the selected page is a cover page that includes a single image 92a. As discussed above, the specific controls 94, 96a, and 98 displayed are automatically selected based on the layout of the particular page depicted by page preview image 92. In the example of FIG. 11, the layout of the selected calendar cover page is identified as having the following characteristics:
single image;
the first of a sequence of pages; and
horizontal biding providing a vertical orientation with respect to the other pages.
   Thus, page browsing controls 94 are selected to mimic the vertical orientation of the pages of the calendar and to reflect the current selection of the cover page. Page editing controls 96a and image editing controls 98 relevant to a single image page are selected.

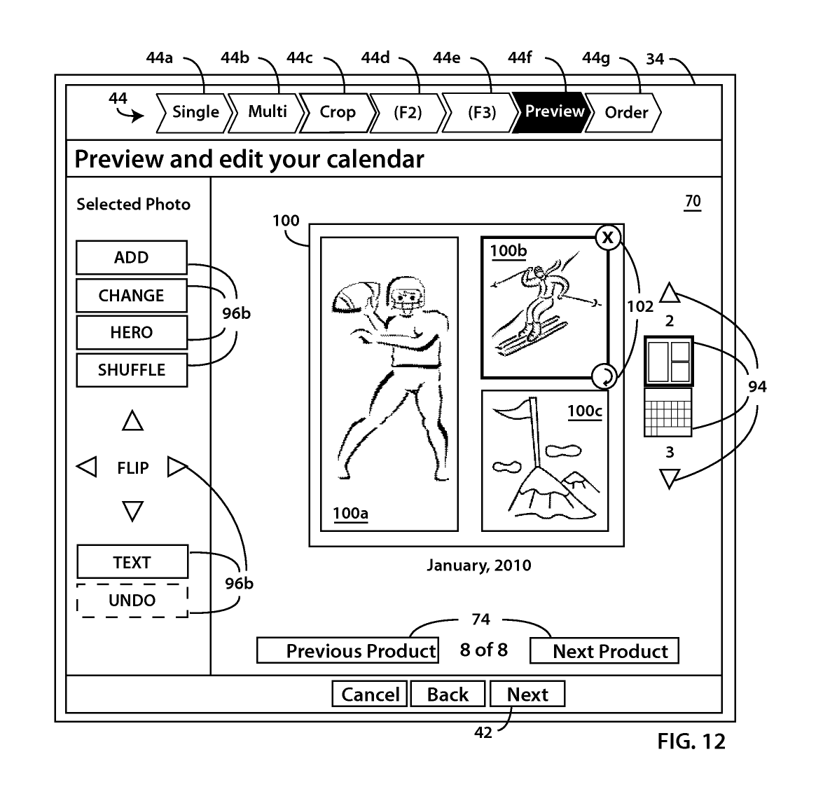

Moving to FIG. 12, the user has manipulated page browsing controls 94 to select the next calendar page. As a result, frame 70 is updated with page preview image 100 providing a visual depiction of the next page of the photobook. In this example, the next page is a multi-image page containing images 100a, 100b, and 100c. The user has selected image 100b causing the display of image edit controls 112. Page edit controls 96b and image edit controls 112 selected to be displayed correspond to the new multi-image layout of preview image 100 and differ from their counterparts selected with respect to the layout of the cover page as depicted in FIG. 11. Furthermore, page browsing controls 94 have been updated to reflect the preview position within the calendar and the selection of the second page.

As noted, the page edit controls 96b selected to be displayed correspond to a multi-image page and include controls for adding an image to a page, changing a selected image, promoting a selected image to “hero” status, and shuffling the images included on the page. Other page editing controls 80a allow a user to add text, “flip” the layout of the included images, and undo previous page editing actions. Here, no page editing actions have occurred, so the “undo” page editing control is not active and is shown in broken lines.

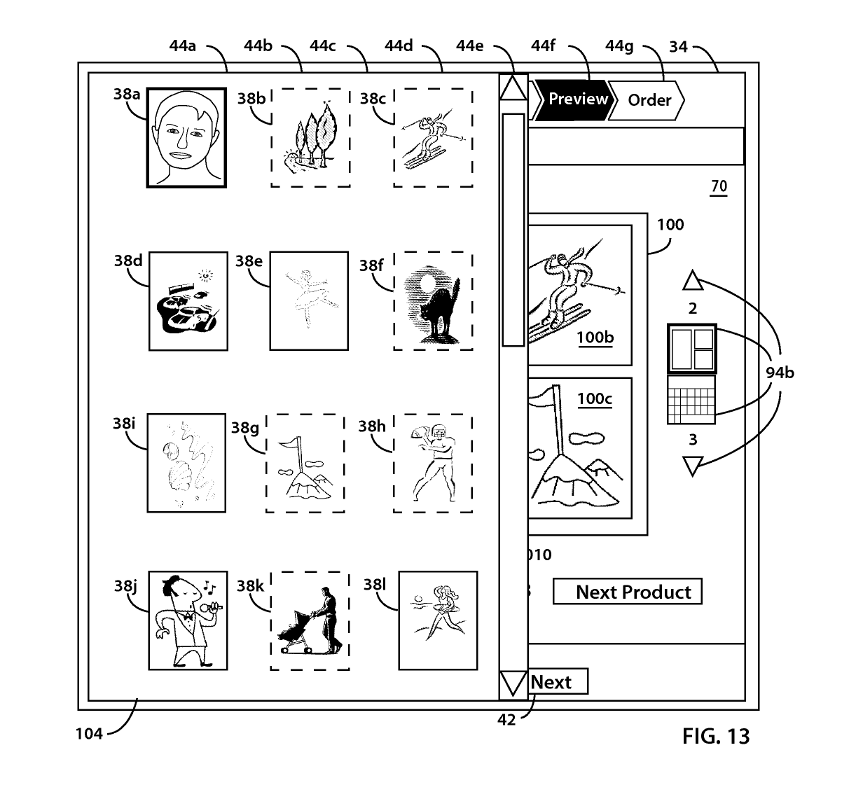

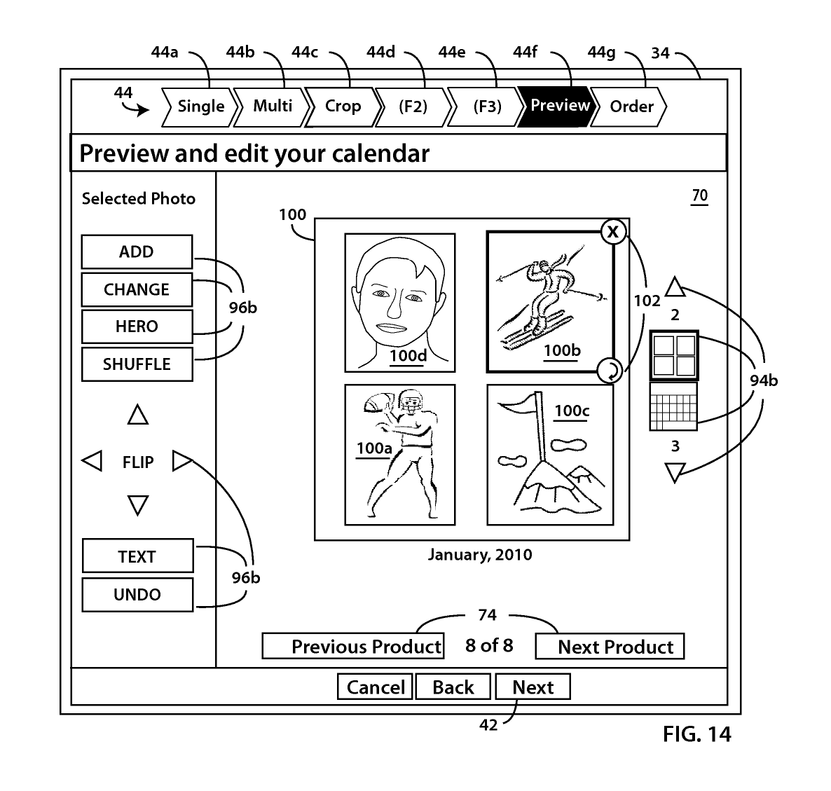

Moving to FIG. 13, the user has selected the “add” page editing control. Frame 70 is updated to include image overlay 104. Image overlay 104 includes image thumbnails 38a-38l. Image thumbnails for those images already selected to populate the calendar are distinguished from the others. Here, those thumbnails are shown in broken lines. However, those thumbnails may still be active for selection allowing the same image to be used more than once to populate the calendar. In this example, the user has selected thumbnail 38a causing overlay 104 to close. Moving to FIG. 14, image 100d has been added to preview image 100 in response to the user's selection of thumbnail 38a in FIG. 13. Referring now to FIG. 15, with image 100b still selected the user has selected the “hero” page editing control 96b. As a result, image 100b has been enlarged with respect to the other images 100a and 110c and newly added image 100d.

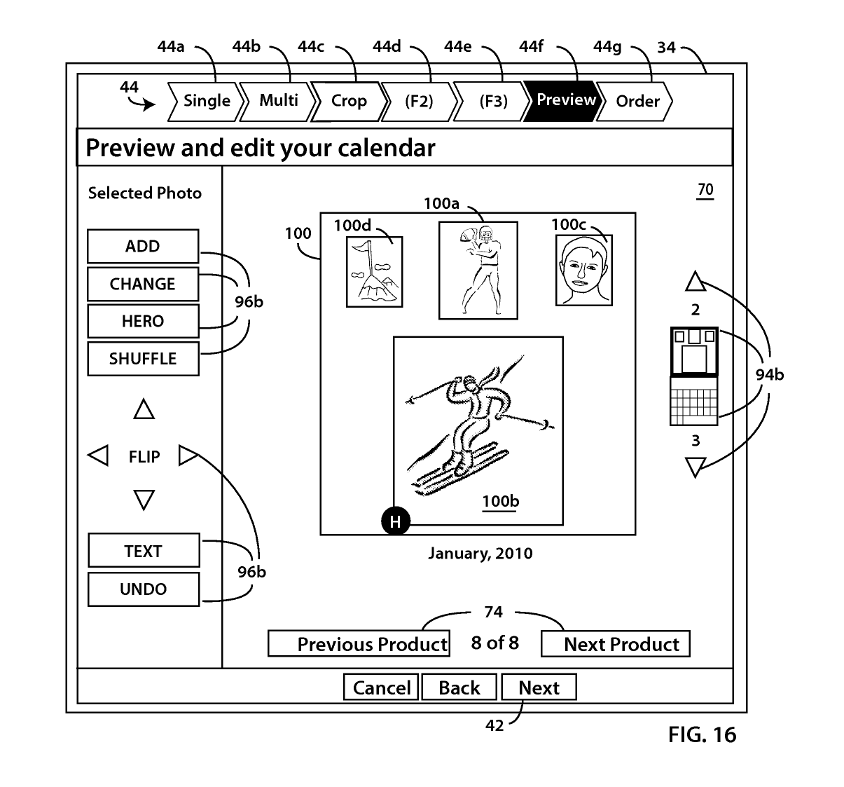

In the example of FIG. 15, image 100b has also been modified to reflect its selection as a “hero” image. Thus, image 100b is identified as having a “hero” state. A hero state, as used herein, means that the specified image is to retain a size that is larger than the other images on a page regardless of future changes made to the page. FIG. 16 provides an example. Her, selection of the “shuffle” page editing control 96b repositions images 100a-100d. Because image 100b has been identified as the “hero” image for the given page, image 100b remains larger than the other images.

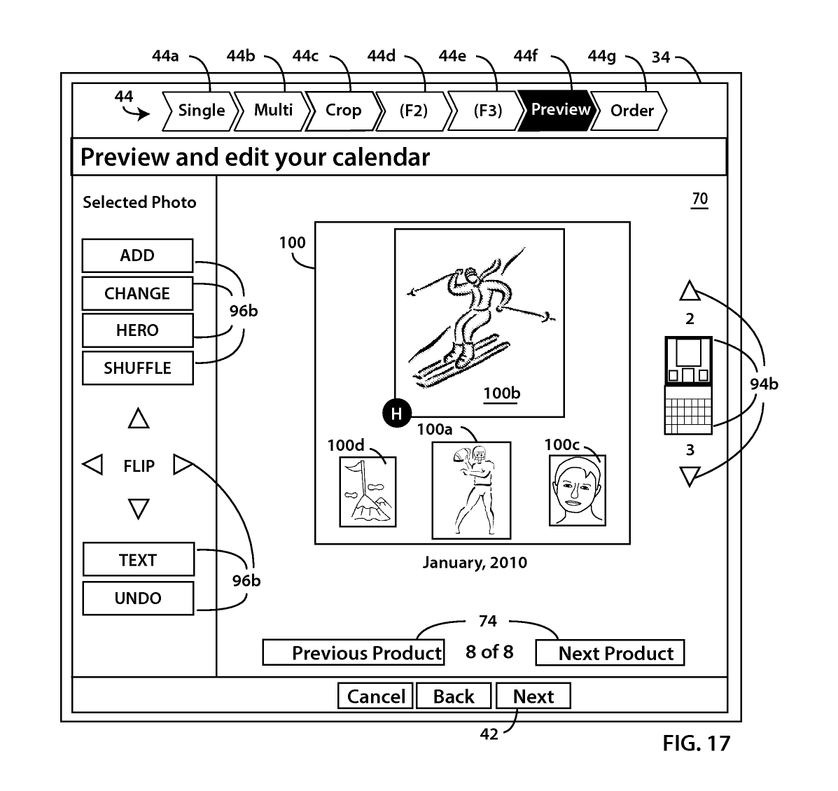

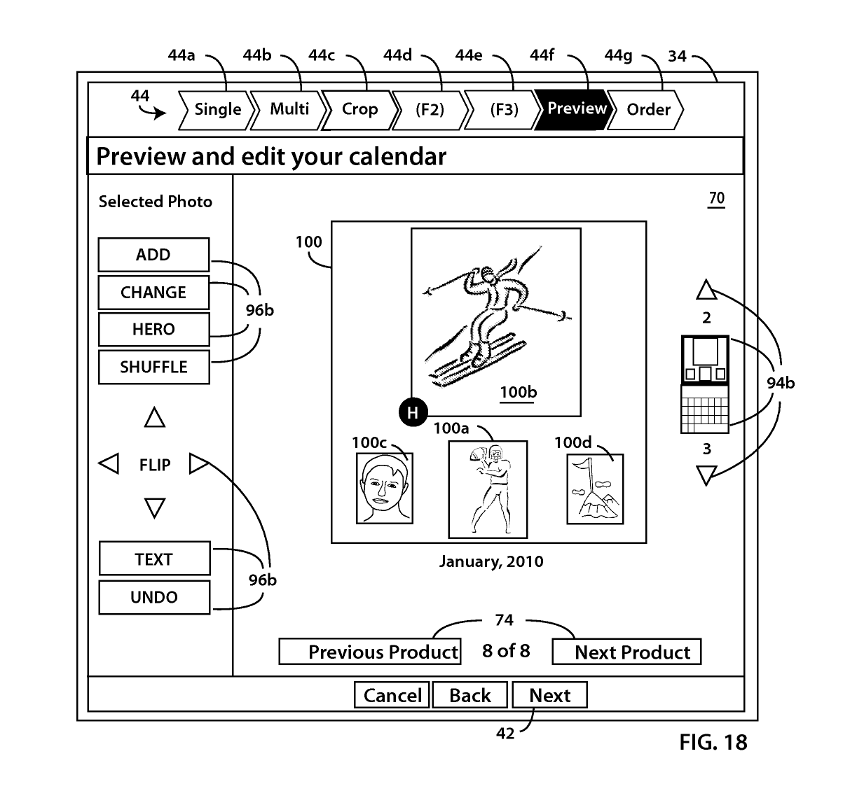

Referring now to FIG. 16-18, user interface 34 also includes a “flip” page editing control that when selected causes the images of a page to “flip” about a particular axis of the page. Upon selection of the “flip” page editing control, images appearing on one side of axis are moved to the opposite side and vice versa. Looking at FIG. 17, a “flip” page editing control corresponding to a horizontal axis has been selected. As a result, page preview image 100 has been updated such that image 100b has been moved to the top and images 100a, 100c, and 100d have been moved to the bottom. Looking at FIG. 18, a “flip” page editing control corresponding to a vertical axis has been selected. As a result, page preview image 100 has been updated such that image 100d has been moved to the right and image 100c has been moved to the left.

In reviewing FIGS. 7-18, the particular controls for page browsing, page editing, and image editing are chosen based on the layout of the page selected to be previewed. Certain page editing and image editing controls are displayed if the selected page includes a single image images. Different controls are displayed if the selected page includes multiple images. Assuming the selected page is of a multi-page product, the particular page browsing control chosen to be displayed depends on the products binding orientation. This dynamic selection of controls presented allows a user to preview and edit disparate product types in a single workflow.

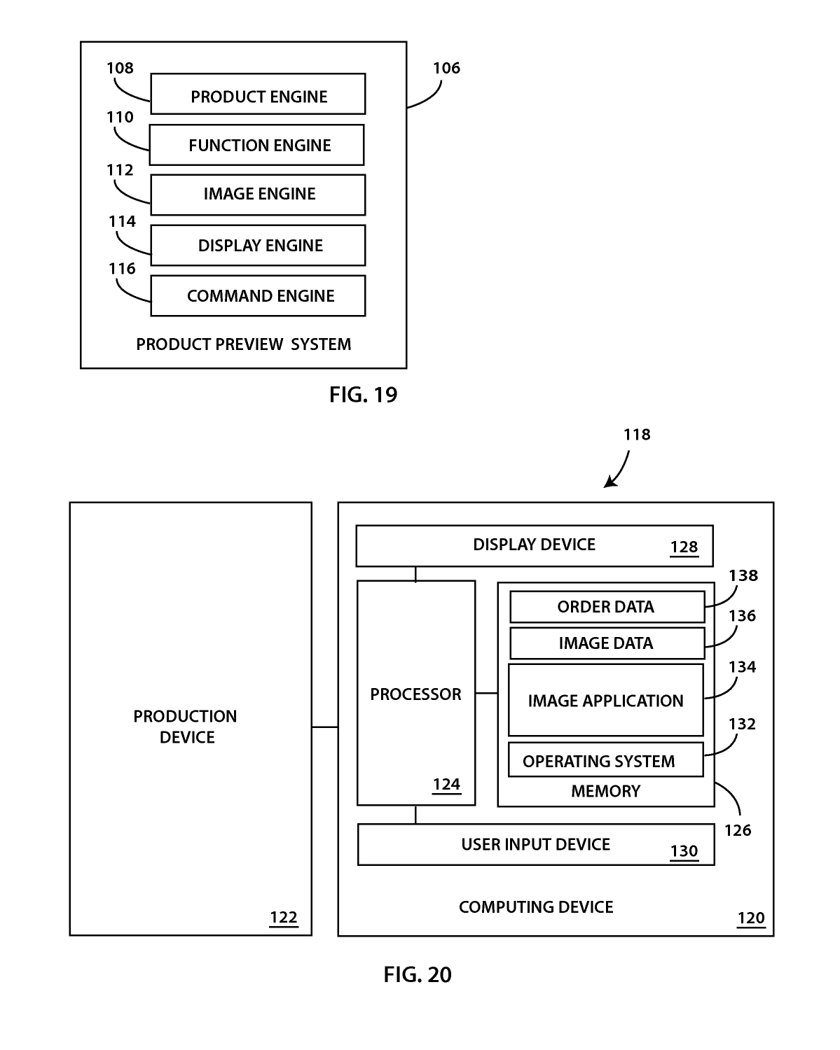

COMPONENTS: FIG. 19 depicts various physical and logical components that function as product preview system 106. System 106 is shown to include product engine 108, function engine 110, image engine 112, display engine 114, and command engine 116. Product engine 108 represents generally any combination of hardware and programming for defining the single and multi-image products available for ordering. Definitions for the single image products can define print sizes and the available media on which the digital images can be formed. Such media can include photo paper, coffee mugs, clothing, and the like. Thus, one single image product may include an eight by ten image formed on photo paper. Another single image product may be defined as four by four image formed on a mouse pad.

Function engine 110 represents generally any combination of hardware and programming configured to define one or more functions for editing digital images selected to populate a product or products. Such functions can include cropping, positioning, rotating, resizing, color management, red-eye removal, adding borders, and the like.

Image engine 112 represents generally any combination of hardware and programming configured to generate and modify objects to be displayed as part of a user interface. In particular, image engine 112 is responsible for generating thumbnails from a set of digital images. Image engine 112 is also responsible for generating and modifying thumbnails to be displayed in various frames of a user interface. Initially, image engine 112 is responsible for generating a first set of thumbnails for each of a set of digital images available to a user. Upon selection of a thumbnail from the first set, image engine 112 is responsible for modifying that thumbnail to indicate its selection for populating a give product with a corresponding digital image. FIGS. 3-5, discussed above, provide examples.

Image engine 112 is responsible for generating preview images for selected product pages. Preview images, when displayed, provide visual representations of a product page. As a given product page is edited by, for example, altering, adding, moving or deleting an image, image engine 112 is responsible for updating the preview image for that product page. Certain products such as prints may include only one product page. Other products such as photobooks and calendars may include multiple product pages. FIGS. 3-18, discussed above, provide examples.

Display engine 114 represents generally any combination of hardware and programming configured to cause, in accordance with a current workflow task, the display of objects generated and modified by image engine 112. Such objects include thumbnails, preview groups, and enlarged preview images. Display engine 114 is also responsible for causing the display of various controls including product selection controls, workflow controls, image selection controls, and page browsing controls, page editing controls, and image editing controls as indicated by the current workflow task and as indicated by command engine 116. FIGS. 3-18, discussed above, provide examples.

Command engine 116 represents generally any combination of hardware and programming configured to detect a user's selections from among the objects caused to be displayed by display engine 114. From the user's selections, command engine 116 generates a list identifying single and multi-image products selected by a user. During a preview task, command engine 116 is responsible for informing image engine 112 of a product page selected to be previewed, to identify a layout of the selected page, and to inform display engine 114 of the various controls to be displayed according to the identified layout. As discussed above, the term layout as used herein refers to the number of images included on a page and the number of pages in a product. For multi-page products the term layout also refers to the page's orientation with respect to other pages of that multi-page product and the page's position within the sequence of pages. FIGS. 3-18, discussed above, provide examples.

System 106 of FIG. 19 may be implemented in a number of environments such as environment 118 of FIG. 120. Environment 118 includes computing device 120 and production device 122. Computing device 120 may be a general purpose computer, a specialized kiosk, or an integrated sub-system of production device 122. Production device 122 represents generally any device or collection of devices capable of producing single and multi-image products ordered via computing device 120.

Computing device 120 is shown to include processor 124, memory 126, display device 128, and user input device 130. Processor 124 represents generally any device capable of executing program instructions stored in memory 126. Memory 126 represents generally any memory configured to store program instructions and other data. Display device 128 represents generally any display device capable of displaying a graphical user interface at the direction of processor 124. User input device 130 represents generally any device such as a mouse, keyboard, or a touch screen through which a user can interact with a user interface presented via display device 128.

Memory 126 is shown to include operating system 132, image application 134, image data 136, and order data 138. Operating system 132 represents generally any software platform on top of which other programs or applications such as image application 134 run. Examples include Linux® and Microsoft Windows®. In this example, operating system 132 includes drivers for controlling the operation of components 128 and 130. In particular, these drivers translate generic commands into device specific commands capable of being utilized by components 128 and 130.

Image application 134 represents generally any programming that, when executed, implements the functionality of engines 108-116 of FIG. 19. Image data 136 represents the digital images image application 134 acts upon. Order data 138 represents data identifying single and multi image products ordered by a user. As noted above, the various components of system 106 of FIG. 19 include combinations of hardware and programming. With respect to FIG. 20, the hardware components may be implemented though processor 124. The programming elements may be implemented via image application 134. In particular, the workflow for selecting, editing, and previewing single and multi-image products may be presented via a user interface generated and managed by image application 134.

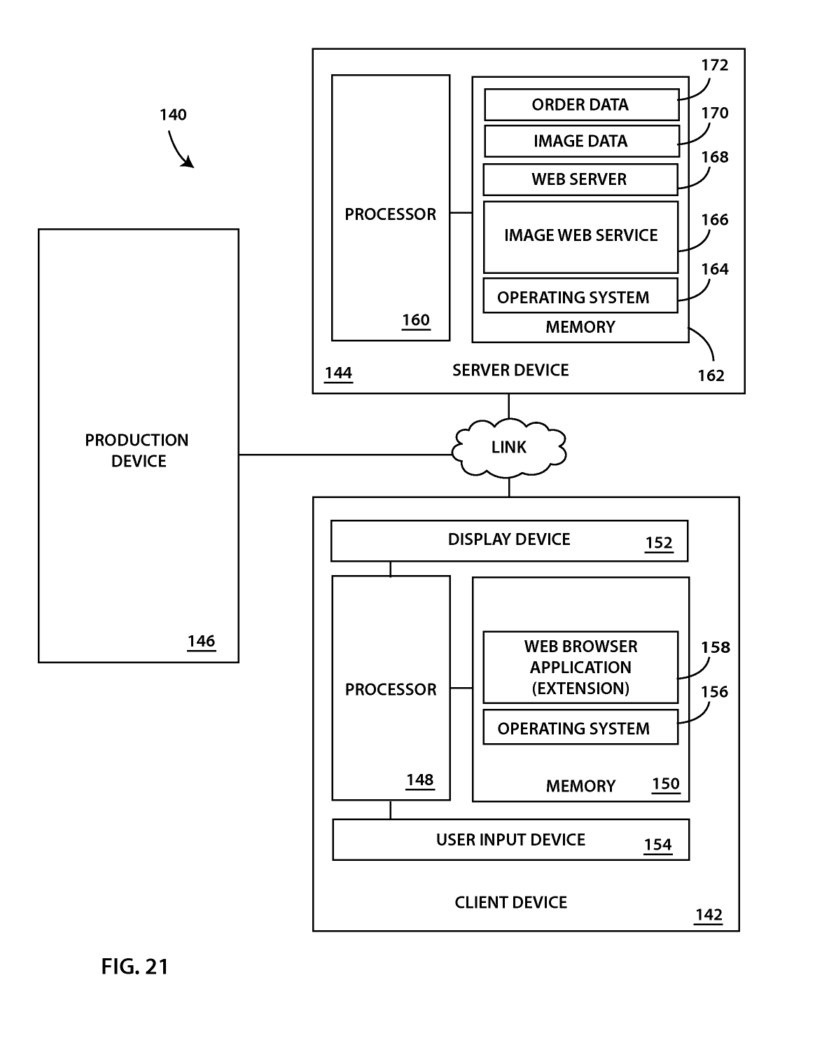

System 106 of FIG. 19 may be implemented in environment 140 of FIG. 21. Environment 140 includes client device 142, server device 144, and production device 146. Client device 142 may be a general purpose computer, a specialized kiosk, or an integrated sub-system of production device 146. Server device 144 represents any computing device capable of serving content. Production device 146 represents generally any device or collection of devices capable of producing single and multi-image products ordered via client device 142 and server device 144.

Client device 142 is shown to include processor 148, memory 150, display device 152, and user input device 154. Processor 148 represents generally any device capable of executing program instructions stored in memory 150. Memory 150 represents generally any memory configured to store program instructions and other data. Display device 152 represents generally any display device capable of displaying a graphical user interface at the direction of processor 148. User input device 154 represents generally any device such as a mouse, keyboard, or a touch screen through which a user can interact with a user interface presented via display device 152.

Memory 150 is shown to include operating system 156 and web browser application 158. Operating system 156 represents generally any software platform on top of which other programs or applications such as web browser application 158 run. Examples include Linux® and Microsoft. Windows®. In this example, operating system 146 includes drivers for controlling the operation of components 152 and 154. In particular, these drivers translate generic commands into device specific commands capable of being utilized by components 152 and 154. Web browser application 158 represents generally any programming that, when executed by processor 148, requests and causes a display of content served by server device 144. Web browser application 158 is also responsible for communicating data indicative of user input back to server device 144.

Server device 144 is shown to include processor 160 and memory 162. Processor 160 represents generally any device capable of executing program instructions stored in memory 162. Memory 162 represents generally any memory configured to store program instructions and other data. Memory 162 is shown to include operating system 164, image web service 166, web server 168, image data 170, and order data 172. Operating system 164 represents generally any software platform on top of which other programs or applications such as service 166 and server 168 run. Examples include Linux® and Microsoft Windows®.

Image web service 166 in combination with web server 168 represents generally any programming that, when executed, implements the functionality of engines 108-116 of FIG. 21. Image data 170 represents the digital images image web service 166 acts upon. Order data 172 represents data identifying single and multi image products ordered by a user and indicated by communications received by web server 168 from client device 142.

As noted above, the various components of system 106 of FIG. 19 include combinations of hardware and programming. With respect to FIG. 21, the hardware components may be implemented though processor 160. The programming elements may be implemented via image web service 166 and web server 168. In particular the workflow for selecting, previewing, and editing single and multi-image products may be presented and managed via content generated by image web service 166 and served by web server 168.

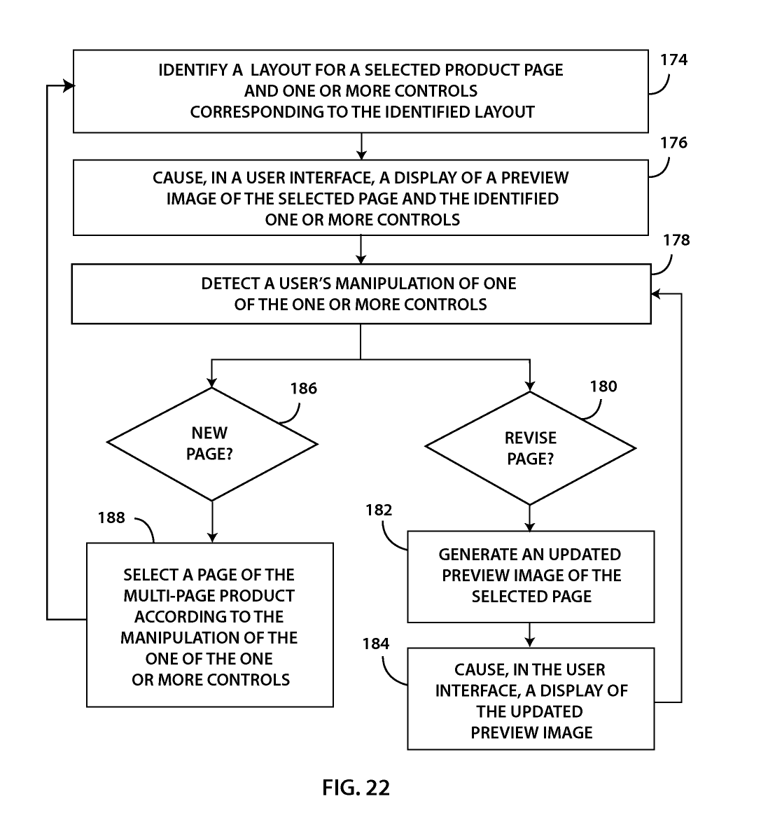

OPERATION: FIG. 22 is an exemplary flow diagram of steps taken to implement an embodiment providing a common workflow for selecting, previewing, and editing single and multi image products. In discussing FIG. 22, reference may be made to the diagrams of FIGS. 1-21 to provide contextual examples. Implementation, however, is not limited to those examples.

Initially, a user may select one from among a plurality of products. That plurality of products can include single and multi-page products with each page populated with one or more digital images. The layout of a selected product page of the selected product is identified along with controls that correspond to the identified layout (step 174). A product page layout corresponds to the number of images included on a page and the number of pages in a product. For multi-page products the term layout also refers to the page's orientation with respect to other pages of that multi-page product and the page's position within the sequence of pages. Referring to FIG. 19, command engine 116 may be responsible for implementing step 174.

The identified controls can include page editing, image editing, and page browsing controls. Page editing controls are controls that, when selected by a user, are indented to alter the appearance of a selected product page. Such page editing controls may affect the appearance of multiple images. Image editing controls are controls that, when selected by a user, affect a single image. Certain page editing and image editing controls correspond to product pages that include a single image while other page editing and image editing controls correspond to product pages that include multiple images. Page browsing controls are controls that, when manipulated by a user, cause the display of a selected page of a multi-page product. For multi-page products, different page browsing controls correspond to each page of that product. Further, the page browsing controls that correspond to a multi-page product with a vertical binding can differ from the page browsing controls that correspond to a product with a horizontal binding. Examples of various page browsing, page editing, and image editing controls are depicted in FIGS. 7-18.

In a user interface, a display is caused of the one or more identified controls along with a preview image of the selected page (Step 176). Referring to FIG. 19, display engine 114 may be responsible for implementing step 176. FIGS. 7-18 depict examples in which different preview images and different controls are caused to be displayed as part of a user interface.

A user's manipulation of one the one or more controls is detected (step 178). Referring again to FIG. 19, command engine 116 may be responsible for implementing step 178. The manipulated control may be a page editing or image editing control reflecting a user's desire to revise the page (step 180). In this case, an updated preview image of the selected page is generated (step 182), and a display of the updated preview image is caused in the user interface (step 184). The preview image is updated according the manipulation of the one or more controls. Following step 184, the process skips back to step 178. Referring to FIG. 19, image engine 112 may be responsible for implementing step 182, while display engine 114 implements step 184.

The preview image displayed in step 176 may include a plurality of user selectable images, and step 168 may include detecting a user's selection of one of the plurality of images followed by a selection of a page editing control. Where the manipulated page editing control is a “hero” page editing control, the selected image is resized to be the largest of the plurality images in step 182. The identified image may retain a “hero” state such that it remains the largest of the plurality of images even after the user manipulates another page editing control that causes the plurality of images to be repositioned or resized when step 182 is repeated.

The manipulated control detected in step 178 may instead be a page browsing control reflecting a user's desire to select and preview a new page of a given multi-page product. In this case, a page is selected of the multi-page product according to the manipulation of the one or more control (step 188), and the process repeats with step 174.

In step 174, the layout of the selected product page may be identified as a first page of a multi-page product. As a consequence, one of the one or more identified controls in step 174 is a page browsing control reflecting the selected product page's position within a sequence of pages. Upon detection of a user's manipulation of the page browsing control in step 178, a new page of the multi-page product is selected. In step 174, the layout of that page is identified as are controls that correspond to the identified layout. In step 176 a display is caused of a preview image for the newly selected page along with the newly identified controls.

CONCLUSION: The diagrams of FIGS. 1-18 are used to depict exemplary environments, components, and user interface displays. Implementation, however, is not so limited. FIGS. 19-21 show the architecture, functionality, and operation of various embodiments. Various components illustrated in FIGS. 19-21 are defined at least in part as programs. Each such component, portion thereof, or various combinations thereof may represent in whole or in part a module, segment, or portion of code that comprises one or more executable instructions to implement any specified logical function(s). Each component or various combinations thereof may represent a circuit or a number of interconnected circuits to implement the specified logical function(s).

Also, the present invention can be embodied in any computer-readable media for use by or in connection with an instruction execution system such as a computer/processor based system or an ASIC (Application Specific Integrated Circuit) or other system that can fetch or obtain the logic from computer-readable media and execute the instructions contained therein. “Computer-readable media” can be any media that can contain, store, or maintain programs and data for use by or in connection with the instruction execution system. Computer readable media can comprise any one of many physical media such as, for example, electronic, magnetic, optical, electromagnetic, or semiconductor media. More specific examples of suitable computer-readable media include, but are not limited to, a portable magnetic computer diskette such as floppy diskettes or hard drives, a random access memory (RAM), a read-only memory (ROM), an erasable programmable read-only memory, or a portable compact disc.

Although the flow diagram of FIG. 22 shows a specific order of execution, the order of execution may differ from that which is depicted. For example, the order of execution of two or more blocks may be scrambled relative to the order shown. Also, two or more blocks shown in succession may be executed concurrently or with partial concurrence. All such variations are within the scope of the present invention.

The present invention has been shown and described with reference to the foregoing exemplary embodiments. It is to be understood, however, that other forms, details and embodiments may be made without departing from the spirit and scope of the invention that is defined in the following claims.

What is claimed is:

1. A method for previewing a plurality of products populated with a plurality of digital images, the method comprising:
identifying a layout of a selected product page of a selected one of the plurality of products;
identifying one or more controls that correspond to the identified layout;
causing, in a user interface, a display of the identified controls and a preview image of the selected product page.

2. The method of claim 1, wherein identifying the layout of the selected product page, comprises identifying one or more of:
a number of images included on the selected product page;
a position of the selected product page in a sequence of pages of a multi-page product; and
an orientation of the selected product page with respect to other pages of a multi-page product.

3. The method of claim 2, wherein identifying the layout of the selected product page and identifying one or more controls that correspond to the identified layout comprises one or more of:
identifying the selected product page as including multiple images and identifying page editing controls that correspond to a multi image page;
identifying the selected product page as including multiple images and identifying image editing controls that correspond to a multi image page;
identifying the selected product page as having a particular orientation with respect to other pages of a multi-page product and identifying page browsing controls that correspond to the particular orientation; and
identifying the selected product page as having a particular position within a sequence of pages of a multi-page product and identifying page browsing controls that correspond to the particular position.

4. The method of claim 1, wherein the selected product page is a first page of a multi-page product, the identified one or more controls are one or more first controls, and the identified layout is a first layout, the method further comprising:
detecting a user's manipulation of one of the one or more controls identified and caused to be displayed, the manipulated control being a page browsing control;
selecting a second product page of the multi-page product according to the manipulation of the page browsing control;
identifying a second layout of the second product page;
identifying one or more second controls that correspond to the second layout; and
causing, in the user interface, a display of the one or more second controls and a preview image of the second product page.

5. The method of claim 1, further comprising:
detecting a user's manipulation of one of the one or more controls identified and caused to be displayed, the manipulated control being one of a page editing control and an image editing control; and
causing, in the user interface, a display of an updated preview image of the selected product page, the preview image having been updated according to the user's manipulation of the one of the one or more controls.

6. The method of claim 5, further comprising detecting a user's selection of one of a plurality of images included in the preview image of the selected product page, and wherein:
the manipulated control is a page editing control; and
causing, in the user interface, a display of an updated preview image of the selected product page comprises causing, in the user interface, a display of an updated preview image of the selected product page, the preview image having been updated such at the selected image has been resized to be larger than the other images included in the updated preview image of the selected product page.

7. The method of claim 1, further comprising:
detecting a user's selection of one of a plurality of images included in the preview image of the selected product page;
in response to detecting a user's manipulation of a first one of the one or more controls, causing, in the user interface, a display of a first updated preview image of the selected product page in which the selected image has been resized to be a largest of the plurality of images; and
in response to detecting the user's manipulation of a second one of the one or more controls, causing, in the user interface, a display of a second updated preview image in which one or both of positions and sizes of the plurality of images are modified while the selected image remains the largest.

8. A computer readable medium storing computer executable instructions that when executed implement a method for previewing a plurality of products populated with a plurality of digital images, the method comprising:
identifying a layout of a selected product page of a selected one of the plurality of products;
identifying one or more controls that correspond to the identified layout;
causing, in a user interface, a display of the identified controls and a preview image of the selected product page.

9. The method of claim 8, wherein applying identifying the layout of the selected product page, comprises identifying one or more of:
a number of images included on the selected product page;
a position of the selected product page in a sequence of pages of a multi-page product; and
an orientation of the selected product page with respect to other pages of a multi-page product.

10. The medium of claim 9, wherein identifying the layout of the selected product page and identifying one or more controls that correspond to the identified layout comprises one or more of:
identifying the selected product page as including multiple images and identifying page editing controls that correspond to a multi image page;
identifying the selected product page as including multiple images and identifying image editing controls that correspond to a multi image page;
identifying the selected product page as having a particular orientation with respect to other pages of a multi-page product and identifying page browsing controls that correspond to the particular orientation; and
identifying the selected product page as having a particular position within a sequence of pages of a multi-page product and identifying page browsing controls that correspond to the particular position.

11. The medium of claim 8, wherein the selected product page is a first page of a multi-page product, the identified one or more controls are one or more first controls, and the identified layout is a first layout, the method further comprising:
detecting a user's manipulation of one of the one or more controls identified and caused to be displayed, the manipulated control being a page browsing control;
selecting a second product page of the multi-page product according to the manipulation of the page browsing control;
identifying a second layout of the second product page;
identifying one or more second controls that correspond to the second layout; and
causing, in the user interface, a display of the one or more second controls and a preview image of the second product page.

12. The medium of claim 8, wherein the method further comprises:
detecting a user's manipulation of one of the one or more controls identified and caused to be displayed, the manipulated control being one of a page editing control and an image editing control; and
causing, in the user interface, a display of an updated preview image of the selected product page, the preview image having been updated according to the user's manipulation of the one of the one or more controls.

13. The medium of claim 12, wherein the method further comprises detecting a user's selection of one of a plurality of images included in the preview image of the selected product page, and wherein:
the manipulated control is a page editing control; and
causing, in the user interface, a display of an updated preview image of the selected product page comprises, causing, in the user interface, a display of an updated preview image of the selected product page, the preview image having been updated such at the selected image has been resized to be larger than the other images included in the updated preview image of the selected product page.

14. The medium of claim 8, wherein the method further comprises:
detecting a user's selection of one of a plurality of images included in the preview image of the selected product page;
in response to detecting a user's manipulation of a first one of the one or more controls, causing, in the user interface, a display of a first updated preview image of the selected product page in which the selected image has been resized to be a largest of the plurality of images; and
in response to detecting the user's manipulation of a second one of the one or more controls, causing, in the user interface, a display of a second updated preview image in which one or both of positions and sizes of the plurality of images are modified while the selected image remains the largest.

15. A system for previewing a plurality of products populated with a plurality of digital images, the system comprising display engine and a command engine, wherein:
the command engine is operable to identify a layout of a selected product page of a selected one of the plurality of products and to identify one or more controls that correspond to the identified layout; and
the display engine is operable to cause, in a user interface, a display of the identified controls and a preview image of the selected product page.

16. The system of claim 15, wherein the command engine is operable to identify the layout of the selected product page by identifying one or more of:
a number of images included on the selected product page;
a position of the selected product page in a sequence of pages of a multi-page product; and
an orientation of the selected product page with respect to other pages of a multi-page product.

17. The system of claim 16, wherein the command engine is operable to identify the layout of the selected product page and identify one or more controls that correspond to the identified layout by performing one or more of:
identifying the selected product page as including multiple images and identifying page editing controls that correspond to a multi image page;
identifying the selected product page as including multiple images and identifying image editing controls that correspond to a multi image page;
identifying the selected product page as having a particular orientation with respect to other pages of a multi-page product and identifying page browsing controls that correspond to the particular orientation; and
identifying the selected product page as having a particular position within a sequence of pages of a multi-page product and identifying page browsing controls that correspond to the particular position.

18. The system of claim 15, wherein the selected product page is a first page of a multi-page product, the identified one or more controls are one or more first controls, and the identified layout is a first layout, and wherein:
the command engine is operable to:
detect a user's manipulation of one of the one or more controls identified and caused to be displayed, the manipulated control being a page browsing control;
select a second product page of the multi-page product according to the manipulation of the page browsing control;
identify a second layout of the second product page;
identify one or more second controls that correspond to the second layout; and
the display engine is operable to cause, in the user interface, a display of the one or more second controls and a preview image of the second product page.

19. The system of claim 15, wherein:
the command engine is operable to detect a user's manipulation of one of the one or more controls identified and caused to be displayed, the manipulated control being one of a page editing control and an image editing control; and
the display engine is operable to cause, in the user interface, a display of an updated preview image of the selected product page, the preview image having been updated according to the user's manipulation of the one of the one or more controls.

20. The system of claim 19, wherein;
the command engine is operable to detect a user's selection of one of a plurality of images included in the preview image of the selected product page;
the manipulated control is a page editing control; and
the display engine is operable to cause, in the user interface, a display of an updated preview image of the selected product page, the preview image having been updated such at the selected image has been resized to be larger than the other images included in the updated preview image of the selected product page.
